(19) United States
(12) Patent Application Publication
(10) Pub. No.: US 2022/0360639 A1
(43) Pub. Date: Nov. 10, 2022

(54) SYSTEM AND METHOD FOR PROVIDING ON-DEMAND LEGAL COUNSEL AND DECENTRALIZED TRUSTED NETWORKS

(71) Applicant: Joey McCall, Miami, FL (US)

(72) Inventor: Joey McCall, Miami, FL (US)

(21) Appl. No.: 17/740,247

(22) Filed: May 9, 2022

Related U.S. Application Data
(60) Provisional application No. 63/185,707, filed on May 7, 2021.

(51) Int. Cl. H04L 67/306; H04L 67/52

(52) U.S. Cl. CPC H04L 67/306; H04L 67/52; G06Q 50/18

(57) ABSTRACT

A system for providing on-demand legal counsel is disclosed, including a database in operable communication with a computing device. The computing device is in communication with a user interface module to display information on a display of the computing device. A user profile interface to permit the input of a plurality of profile information and a plurality of preferences, wherein a matching engine uses the plurality of profile information and the plurality of preferences to match a lawyer with a user.

### CROSS-REFERENCE TO RELATED APPLICATIONS

The present application claims priority to U.S. Provisional Application No. 63/185,707 filed May 7, 2021, titled “SYSTEM AND METHOD FOR PROVIDING ON-DEMAND LEGAL COUNSEL,” which is hereby incorporated by reference in its entirety.

### TECHNICAL FIELD

The embodiments generally relate to computerized systems and methods for providing on-demand legal counsel.

### BACKGROUND

Often, individuals feel uncomfortable when interacting with law enforcement due, at least in part, to the fear of not knowing their constitutional rights and having a lack of experience in managing legal proceedings. Many individuals will not seek the advice of legal counsel until after they are arrested. This leaves the opportunity for a law enforcement officer to take advantage of the individual's lack of knowledge and increases the potential that the law enforcement officer may act unconstitutionally during the interaction to gather evidence.

In fact, according to FBI statistics, ten million people are arrested annually at a rate of 27,397 per day. The rate of wrongful conviction of people arrested is estimated to be between two and ten percent or approximately 200,000 to one million. Studies show that more than half of wrongful convictions are due to police misconduct. Between 2015 and 2021, America's twenty largest cities paid a combined $2.2 billion in settlements and awards for wrongful convictions and police misconduct. Clearly, police misconduct and wrongful arrests have a detrimental effect on both the people being arrested and the broader community, including taxpayers.

Unfortunately, most victims of police misconduct and wrongful arrest have no evidence or witnesses and the right to a lawyer is only provided after the person has been charged with a crime. To date, no technology exists that provides access to a lawyer during an encounter with law enforcement.

Advances in computing devices and communication technologies allow for people to connect quickly and exchange information. While easy and convenient connection is commonplace in social media applications for casual conversations, the legal industry has yet to adopt data driven methods for communicating with clients, often leaving clients underrepresented at crucial moments.

SUMMARY

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for providing on-demand legal counsel, including at least one database in operable communication with or stored in connection with a computing device such as a server. The computing device is in communication with a user device having an interface module to display information on a display of the user device. A user profile interface permits client users and lawyer users to input a plurality of profile information and a plurality of preferences. A matching engine uses the profile information and the plurality of preferences to match a lawyer with a user.

In one aspect, the system includes a GPS module to track, indicate, and utilize a location of a user and a location of a lawyer.

In one aspect, the matching engine is in operable communication with the GPS module to permit the matching engine to match the user to the lawyer by location.

In one aspect, the GPS module determines a juristic entity, and the system transmits a letter of representation to the juristic entity.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a network infrastructure, according to some embodiments;

FIG. 2 illustrates a screenshot of a request help interface, according to some embodiments;

FIG. 3 illustrates a screenshot of a lawyer confirmation interface, according to some embodiments;

FIG. 4 illustrates a screenshot of a profile interface, according to some embodiments;

FIG. 5 illustrates a screenshot of a case request interface, according to some embodiments;

FIG. 6 illustrates a screenshot of an active case interface, according to some embodiments;

FIG. 7 illustrates a screenshot of an earnings interface, according to some embodiments;

FIG. 8 illustrates a system architecture diagram, according to some embodiments;

FIG. 9 illustrates a screenshot of an administrator dashboard interface, according to some embodiments;

FIG. 10 illustrates a screenshot of a lawyer information page interface, according to some embodiments;

FIG. 11 illustrates a system infrastructure diagram, according to some embodiments;

FIG. 12 illustrates a screenshot of a landing page interface, according to some embodiments;

FIG. 13 illustrates a screenshot of a contact page interface, according to some embodiments;

FIG. 14 illustrates a screenshot of a privacy page interface, according to some embodiments;

FIGS. 15A-15B illustrate a screenshot of a support page interface, according to some embodiments;

FIG. 16 illustrates a screenshot of a lawyer page interface, according to some embodiments;

FIG. 17 illustrates a screenshot of an about page interface, according to some embodiments;

FIG. 18 illustrates a screenshot of a registration page interface, according to some embodiments;

FIG. 19 illustrates a screenshot of a sign in page interface, according to some embodiments;

FIG. 20 illustrates a screenshot of a password reset page interface, according to some embodiments;

FIG. 21 illustrates a screenshot of a lawyer information page interface, according to some embodiments;

FIG. 22 illustrates a screenshot of a dashboard page interface, according to some embodiments;

FIG. 23 illustrates a screenshot of a users page interface, according to some embodiments;

FIG. 24 illustrates a screenshot of a user edit page interface, according to some embodiments;

FIG. 25 illustrates a screenshot of an approve page interface, according to some embodiments;

FIG. 26 illustrates a screenshot of a notes review approve page interface, according to some embodiments;

FIG. 27 illustrates a screenshot of a CMS page interface, according to some embodiments;

FIG. 28 illustrates a screenshot of an email template page interface, according to some embodiments;

FIG. 29 illustrates a screenshot of a settings page interface, according to some embodiments;

FIG. 30 illustrates a screenshot of a settings page create new field interface, according to some embodiments;

FIG. 31 illustrates a screenshot of a meta page interface, according to some embodiments;

FIG. 32 illustrates a screenshot of a login screen interface, according to some embodiments;

FIGS. 33A-33B illustrate screenshots of a home page interface, according to some embodiments;

FIG. 34 illustrates a screenshot of a navigation menu interface, according to some embodiments;

FIG. 35 illustrates a screenshot of a history screen interface, according to some embodiments;

FIG. 36 illustrates screenshots of a sign up interface, according to some embodiments;

FIG. 37 illustrates a trusted network user interface initiation screen, according to some embodiments;

FIG. 38 illustrates a trusted network user interface screen with contacts, according to some embodiments;

FIG. 39 illustrates a trusted network user interface network search screen, according to some embodiments;

FIG. 40 illustrates a trusted network user interface network search screen with information included, according to some embodiments;

FIG. 41 illustrates a trusted network user interface addition confirmation screen, according to some embodiments;

FIG. 42 illustrates a trusted network user interface removal confirmation screen, according to some embodiments;

FIG. 43 illustrates a trusted network user interface recordings list screen, according to some embodiments;

FIG. 44 illustrates a trusted network user interface recording play screen, according to some embodiments;

FIG. 45 illustrates a trusted network user interface stream start confirmation screen, according to some embodiments;

FIG. 46 illustrates a trusted network user interface alert screen, according to some embodiments;

FIG. 47 illustrates a trusted network user interface livestream viewing screen, according to some embodiments;

FIG. 48 illustrates a trusted network user interface comment screen, according to some embodiments;

FIG. 49 illustrates a trusted network user interface location display screen, according to some embodiments; and

FIG. 50 illustrates a trusted network user interface livestream termination screen, according to some embodiments.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system and method for providing on-demand legal counseling. The system allows for the creation of user profiles which are used to match clients with lawyers based on location, fees, and area of law in which the lawyer practices. The system allows the client to record interactions which are time-stamped and stored in the database. Further, the system generates a digital card which includes the name and constitutional rights of the client, which is meant to be viewed by the body camera of a police officer. A jurisdictional map is provided to illustrate who has jurisdiction at a particular location. This allows the system to send a letter of representation to the juristic entity and notify the police department of the representation of the client.

In one embodiment, in order to protect a user's civil rights, the system can perform several steps. First, the system can use a GPS module to identify a law enforcement jurisdiction the user is located. Next the system can create or select a customized notice that the user can review and show to law enforcement officers detailing and invoking the users fourth, fifth, and sixth amendment rights, as well as any rights afforded by the local jurisdiction. Next, a customized notice invoking the users civil rights can be electronically transmitted to the law enforcement office in the jurisdiction. In various embodiments, a record of such transmission can be recorded on a distributed ledger using blockchain technology.

In one example, a user utilizes the system via their computing device (smartphone, etc.) upon contact with an authority (e.g., a police officer) to request legal representation. As a first step, the system can use a GPS module to match the user with a lawyer in their area who is available. Further, the user preferences may aid in the match-making process. Once a lawyer accepts the inquiry, a payment is submitted by the user and the information exchange is started. The lawyer may then be provided with personal information (e.g., the users license information, contact information, profile data, and their GPS location).

In some embodiments, payment is transmitted in predetermined time intervals, such as at the end of each month. Payment information can be stored in a payment database and recalled by the system or entered on a per transaction basis.

One skilled in the arts will readily understand that the embodiments provided herein may be applied to various areas of law and is not restricted to criminal justice, civil rights, or other examples provided.

In various embodiments users may be able to connect with friends, family, attorneys, or others in their trusted network. Users can interact with the system and the system can send invitations to their trusted network to register with the system. In registering they may also download an application to a smartphone or other computing device. At the push of a button, one or more people from a user's trusted network may be notified that the user is involved in what they perceive or consider to be a dangerous law enforcement encounter. Upon notification of the person(s) in the trusted network, the user's location can be shared so the person(s) know where the interaction is taking place.

In an example embodiment, a user who is stopped by law enforcement and who may not have the money to pay a lawyer can inform their trusted network of their whereabouts by pressing a distress button through the application stored on their smartphone. Once the trusted network members receive the notification, they will be provided with the user's location and can travel to the scene to hopefully serve as witnesses and provide support for the user. Additionally or alternatively, users and trusted network members can stream video via a network connection and notify one or more people such as a lawyer, bondsman, or others. Video recording can also be enabled, such that a record of event is created and saved. In some embodiments, video, still frames, and/or audio may include a digital watermark, branding, or other signature of the platform so it can be identified on social media, legacy media, or otherwise. In some embodiments feature can be provided for free in order to lead to continued user engagement and would motivation to recommend users join the platform. In some embodiments one or more features may be offered on a subscription, one time, or other payment arrangement.

Additional offerings through the system are also contemplated in various embodiments. In some embodiments these include consultation services that are prerecorded or recorded after an inquiry, i.e. not on-demand or real-time. As such, lawyers who are not available for on-demand service can still participate through the system and engage with clients.

Multiple user roles are associated with the system. Administrator users can be application owner employees and/or managers who are able to manage user data, email templates, page meta data, general settings, and others. They are also able to approve pending requests to join the platform (e.g. from lawyers) and check data reports. Lawyer users are able to use a web and/or mobile application after signup and login and apply for collaboration with the system as a lawyer. Client users are able to use a web and/or mobile application after signup and login. They can also request lawyers. Guest users are able to download a mobile application and view a login page and visit a landing page. Other users with different roles and accessibility are also contemplated.

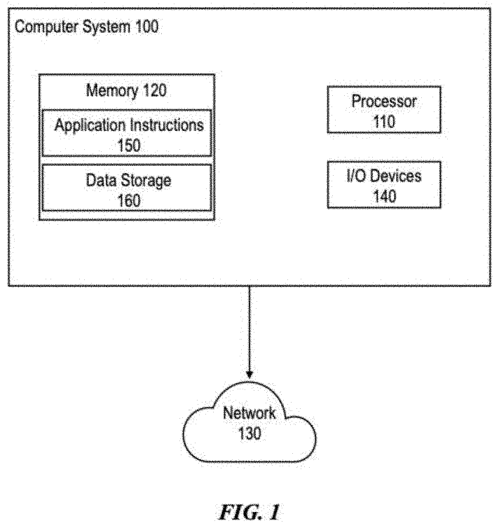

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile tablet device, a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

The system provides both the consumer and the lawyer the opportunity to create a user profile, submit user preferences, and the like. The user can edit their profile, establish preferences, request help from a lawyer, accept or decline help from a lawyer, transmit payments, and transmit communications. Lawyers may edit their profile and establish preferences, see and accept incoming requests, provide help to the user, view their accepted client history, manage clients, and view earnings.

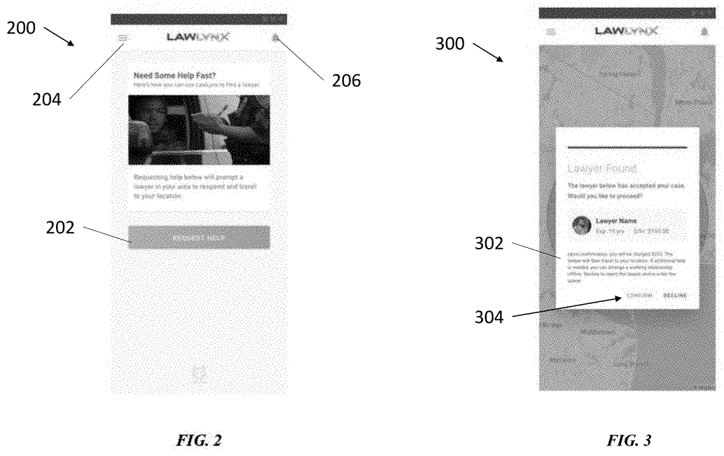

FIG. 2 illustrates a screenshot 200 of the request help interface wherein the user may select to request help from a lawyer, according to some embodiments. As shown in the example embodiment, the user interface can include a “Request Help” button 202 that the user can engage with as displayed via a graphical user interface. Once help is requested by engaging with button 202, the user is matched, via a matching engine, to at least one lawyer based on location, user preferences, area of law of the lawyers (i.e. lawyer speciality), availability, and/or other factors or filters that the user and/or system can specify. A GPS module is operable to identify the user's location via a user device and begins matching with lawyers who are within a predefined radius (e.g., within 10 miles) that can be modified by the user in some instances. Also shown are an interactive menu button 204 and an interactive notification button 206. Menu button 204 will show or hide a user menu when selected. Notification button 206 will show or hide one or more system notifications for the user when selected.

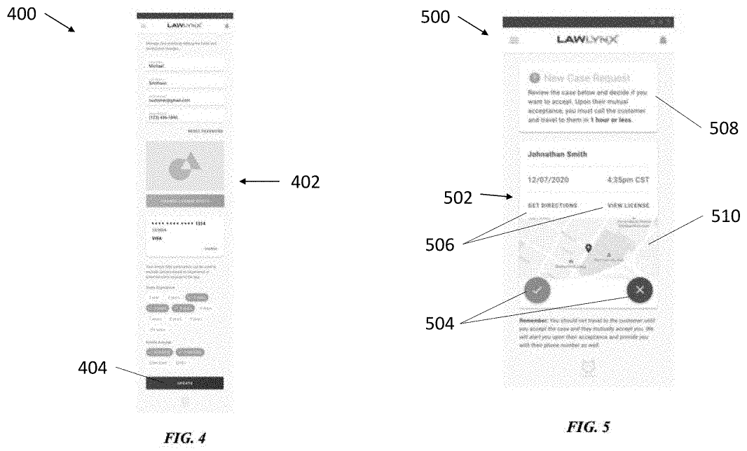

FIG. 3 illustrates a screenshot 300 of a lawyer confirmation interface, according to some embodiments. Once the system matches the user to a lawyer, the lawyer's profile information is transmitted to the user device via a network for display in a lawyer's profile information window 302. The lawyer's profile information may include the lawyer's name, experience, hourly rate, example cases, notes, and/or other biographical or relevant information. The user may then confirm or decline the lawyer by selecting an appropriate button 304 after reviewing their profile information. If the user confirms the match, the system can charge the user a fee and the user can then begin communicating with the lawyer via the system platform. If the user declines the match, the system will continue to attempt to match the user to other lawyers. Payment will be discussed more with respect to FIG. 4 and its associated description herein.

In other embodiments, lists of lawyers can be displayed to the user based on the criteria entered and/or filters and users can select the lawyer they are interested in before the lawyer information window is displayed. Users may also elect not to confirm or decline a particular lawyer and instead close the window through an appropriate control gesture, e.g. by performing a swipe, “x” out of window, tap, or select area outside of window on the display.

FIG. 4 illustrates a screenshot 400 of a lawyer profile interface wherein a lawyer user can input lawyer profile information. For example, lawyer profile information can include personal information 402 the lawyer's name, contact information, license information and imagery, payment credentials, years of experience, hourly rates, and the like. This information is stored in memory and used to match the lawyer with a user requesting help. Certain information can be entered in fields, while other information can be entered by selecting buttons, capturing images using a camera of a user device, selecting radio buttons, or others. A selectable update button 404 can allow a lawyer user to confirm the information entered is correct.

FIG. 5 illustrates a screenshot 500 of a case request interface which can be displayed via a user interface of a user device when a lawyer receives a request for help from a user. The case request interface can display information 502 including the user's name, date and time of the request, and the user's location on a map 510 (that can be third-party integrated or system based). The lawyer may then accept or deny the request by selecting an appropriate corresponding button 504. Once accepted, the lawyer may select button 506 to view directions to the user's location and view the user's profile information such as their driver's license. In some embodiments buttons 506 can be selected prior to the lawyer accepting the request.

In some embodiments, the system may require the lawyer to respond to a request within a predetermined time period and can display such timing information 508. For example, the system may require the lawyer to travel to the user within one hour.

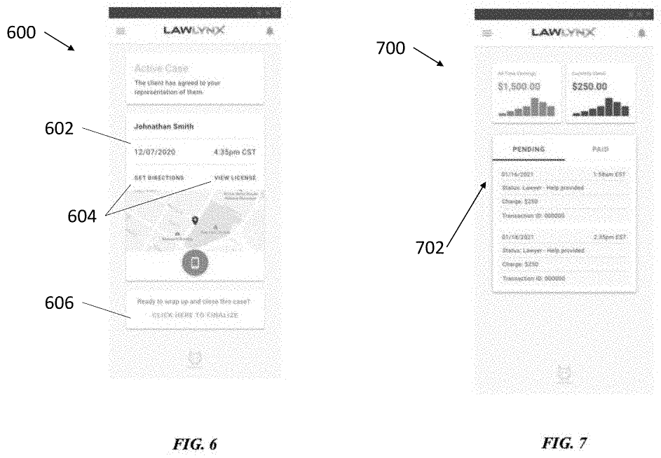

FIG. 6 illustrates a screenshot 600 of an active case interface. The active case interface is displayed to a lawyer once the lawyer accepts a request from a user. The lawyer may view the user's profile information 602, and by selecting appropriate buttons 604 receive directions to the user and/or view the user's license. Further, the lawyer can finalize the case by selecting button 606 when the case is closed or when the user no longer wants or needs the lawyer's services.

FIG. 7 illustrates a screenshot 700 of an earnings interface wherein the lawyer can view financial information 702, including their earning history, outstanding money owed to them, pending payments, and other relevant information. For example, the lawyer may view their all-time earnings alongside the amount they are currently owed. In some embodiments, the lawyer is provided with the status of pending cases to indicate whether or not help was provided, charges applied, and the like. Information 702 can include text, numerical, and graphical elements such as tables, charts, graphs, and others.

In some embodiments, a database stores legal information that can be accessed and viewed on a user display of a user's computing device. As such, the user can consume legal information including information about their rights. The user can also display such information to law enforcement during an interaction with a law enforcement officer.

In some embodiments, a GPS module can be used to view a jurisdictional map that illustrates which law enforcement office/branch and/or judicial branch has jurisdiction at a particular location. This allows the system to send a letter of representation to a juristic entity and to notify the law enforcement office (e.g. police department) of the user's legal representation.

In some embodiments, the user's computing device (i.e., smartphone) may utilize integrated or secondary components such as a camera, microphone, and/or other components to record the interaction between the user and an authority figure (e.g., law enforcement). As such, the computing device can be used to record the interaction as a sort of unofficial “body camera” along the lines of those issued to authorities in some jurisdictions. The computing device can also be used to display information and shown to the authorities. In one example, the computing device is used to display the user's constitutional rights to the authorities. In another example, the computing device records the interaction and stores the data in non-transitory computer readable memory such as a database to later be used as evidence in a legal case or proceeding. Captured data may also be transmitted to the lawyer for review, comment, and use.

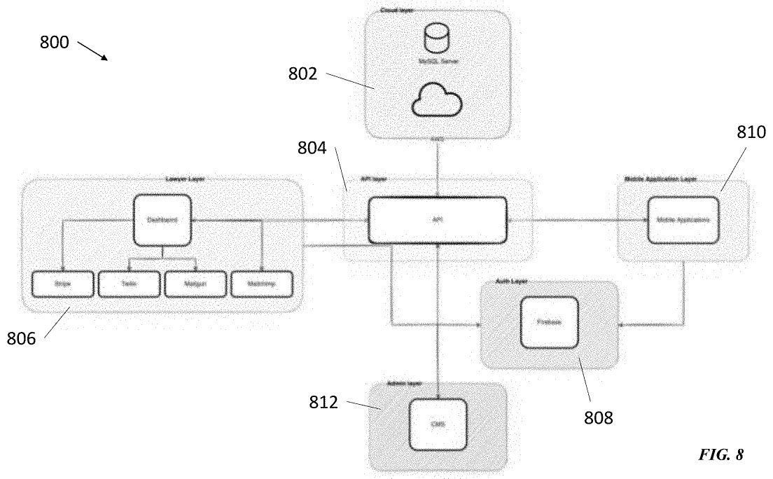

FIG. 8 illustrates a system architecture diagram 800, according to some embodiments. As shown in the example embodiment, a cloud layer 802 can include one or more servers and/or databases to store information and may interact and exchange data with, receive data from, or send data to an API layer 804 that includes an API. A lawyer layer 806 can include payment processors; communication modules such as email, video, and messaging; and location services and can interact and exchange data with, receive data from, or send data to one or both of API layer 804 and Authentication layer 808 that includes one or more authentication modules. API layer 804 can also interact and exchange data with, receive data from, or send data to a mobile application layer 810 that includes one or more mobile applications. Mobile application layer 810 can also interact and exchange data with, receive data from, or send data to Authentication layer 808. Furthermore, An Administration layer 812 can interact and exchange data with, receive data from, or send data to API layer 804.

API layer 804 can allow for secured connection between mobile application and database. Authentication layer 808 can allow for authentication, for instance, using a token-based authentication system that provides integration with the system ecosystem.

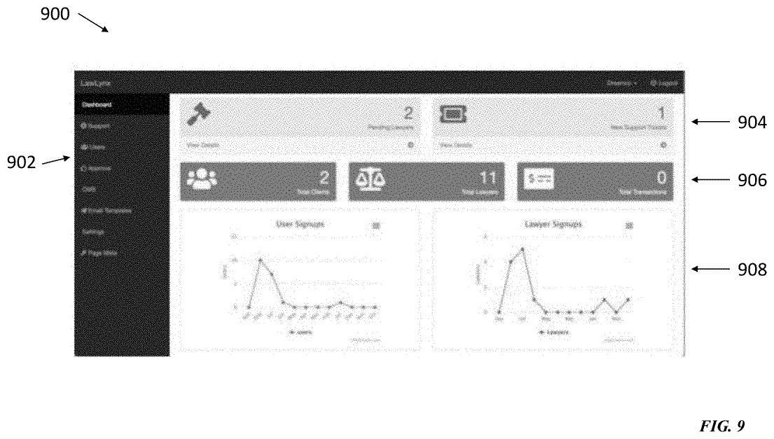

FIG. 9 illustrates a screenshot 900 of an administrator dashboard interface, according to some embodiments. As shown in the example embodiment, an administrator dashboard can exist in an administrator layer that allows project owners to manage user data, email templates, page meta, general settings, and others. Project owners may be the only users who are able to reach administrator dashboard screens. A navigation menu 902 can include buttons allowing an administrator user to view a dashboard, support, users, approve, CMS, email templates, settings, page meta, or other views. A notification section 904 can display one or more system notifications. As shown, these can include reminders about pending lawyers who are waiting to join the platform, pending support tickets, and others. A status section 906 can include information about the total number of clients, the total number of lawyers signed up with the system, total transactions, and others. A visual depiction section 908 can include charts, graphs, or other visual representations of system data for the administrator to review. In the example, charts include user signups and lawyer signups over time.

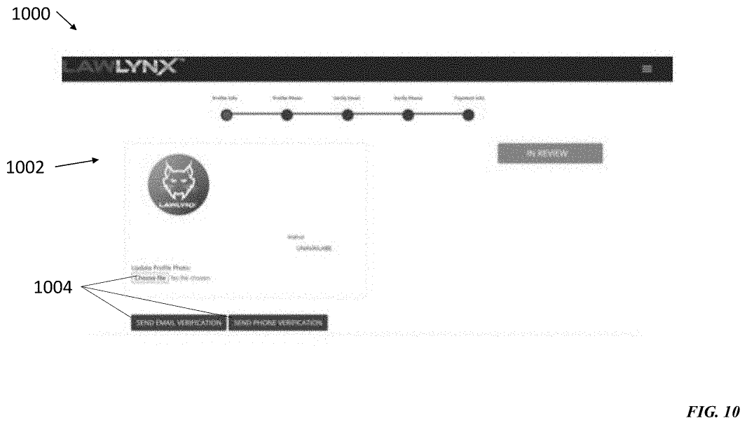

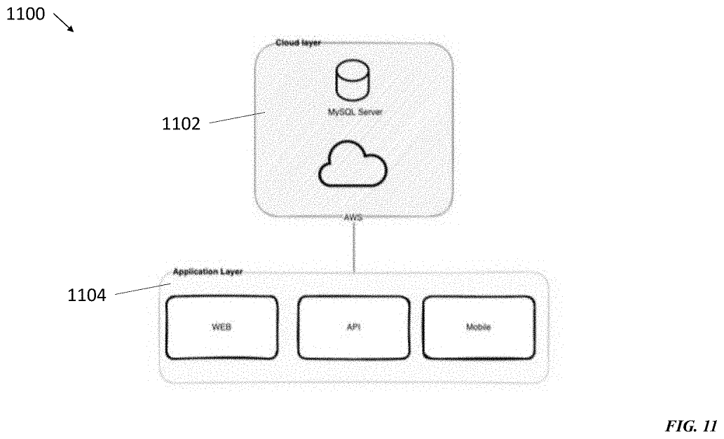

FIG. 10 illustrates a screenshot 1000 of a lawyer information page interface, according to some embodiments. As shown in the example embodiment, a lawyer dashboard can exist in a lawyer layer and can be a web application used for lawyer registration and adding/editing lawyer personal information, verifying contact information such as emails and phone numbers, and including payment details. Only registered lawyers may navigate to this page. Users can view a status chart in section 1002 and interact by selecting buttons 1004 that allow for profile photograph uploads, email verification, phone verification, and others. A status update can also be included, such as “in review.”

FIG. 11 illustrates a system infrastructure diagram 1100, according to some embodiments. As shown in the example embodiment, infrastructure can include a cloud layer 1102 existing in an ecosystem such as Amazon Web Services (AWS). An application layer 1104 can include web, API, and mobile operability.

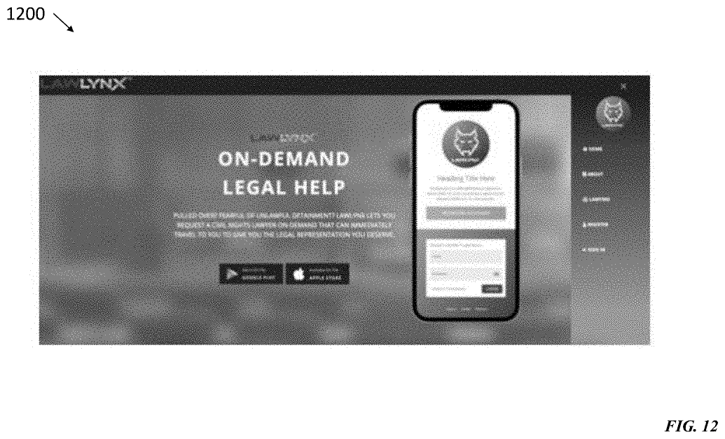

FIG. 12 illustrates a screenshot 1200 of a landing page interface, according to some embodiments. As shown in the example embodiment, a landing page can include marketing presentation details when a user navigates to a system website. The user may be able to visit and review information such as privacy, terms, support, contact us, about, lawyers, register, sign in pages, and others. Users may also subscribe to newsletters and download a corresponding mobile application from an online marketplace or store.

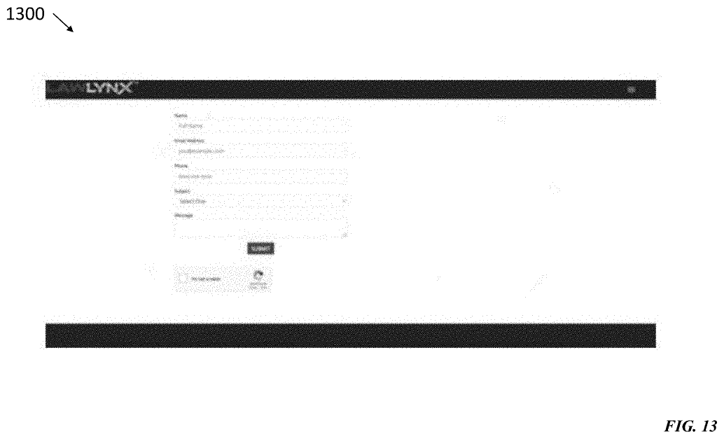

FIG. 13 illustrates a screenshot 1300 of a contact page interface, according to some embodiments. As shown in the example embodiment a contact page can be presented to a user and may be a form with fields that a user can enter information into. Users may also be able to submit questions to system administrators from the contact page. Submit buttons and security features can also be included.

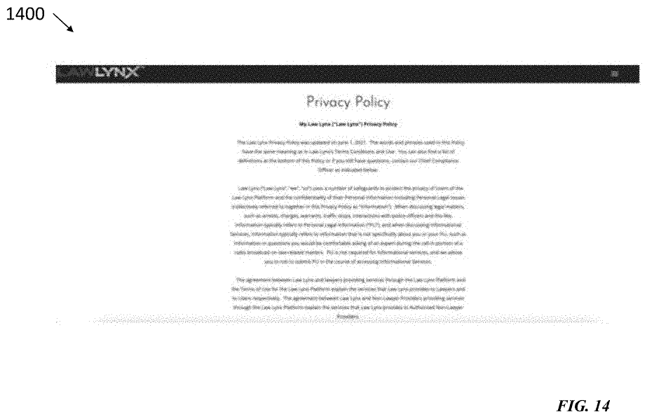

FIG. 14 illustrates a screenshot 1400 of a privacy page interface, according to some embodiments. As shown in the example embodiment, a privacy page can display privacy information for review by users. A terms page may similarly present terms.

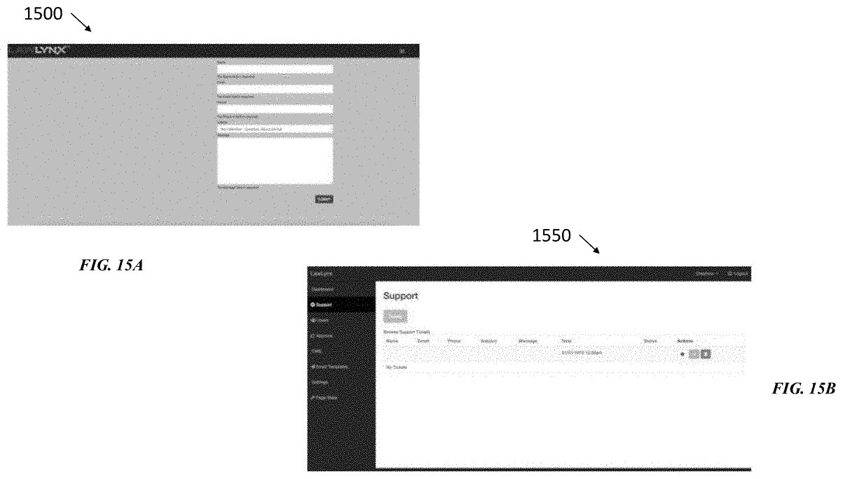

FIGS. 15A-15B illustrate screenshots 1500, 1550 of a support page interface, according to some embodiments. As shown in the example embodiment, if a user selects a support page, the system can display a number of fields for a user to fill information in for submission to a system administrator. These fields can include name, email, phone number, subject, message, and others. One or more dropdown menus can also be included that allow users to select predefined questions and/or categorize their question.

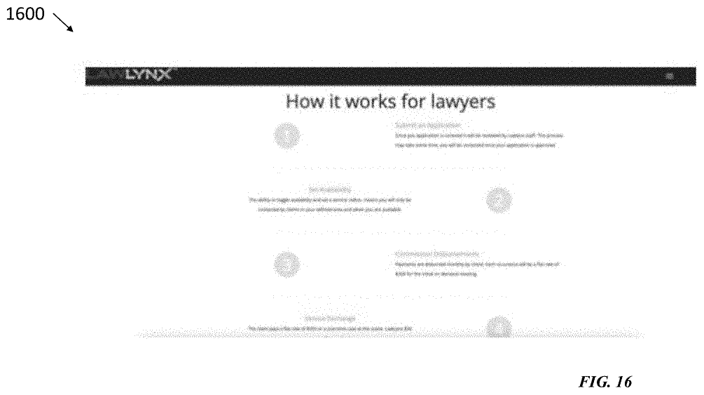

FIG. 16 illustrates a screenshot 1600 of a lawyer page interface, according to some embodiments. As shown in the example embodiment, an explanation of the system can be included for lawyers to review. This can include information about “Submit an Application”: Once a lawyer's application is received it will be reviewed by a system Administrator. This process may take some time and the lawyer will be contacted once your application is approved. “Set Availability”: The ability to toggle availability and set a service radius. means you will only be contacted by clients in your defined area and when you are available. “Commission Disbursements”: Payments can be disbursed monthly or with other frequency by check, digital transfer, cryptocurrency, or others. Each occurrence can have a flat rate, e.g. $149.95 for the initial on demand meeting. “Service Exchange”: The client pays a flat rate, e.g. $149.95 or a one-time case at the scene. “After the Fact”: Any interaction after the first meeting is disassociated from the app, and billing may be handled directly with the client as usual.

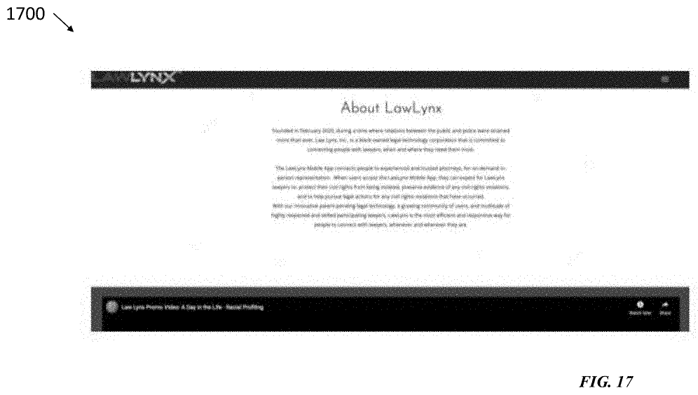

FIG. 17 illustrates a screenshot 1700 of an about page interface, according to some embodiments. An about page can explain information about the system and may be managed by system administrators.

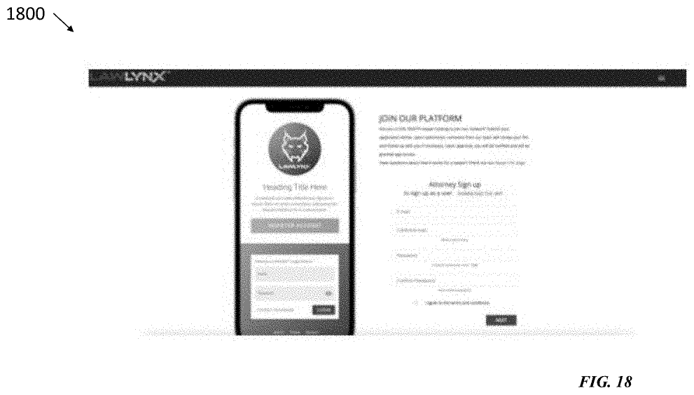

FIG. 18 illustrates a screenshot 1800 of a registration page interface, according to some embodiments. As shown, users can enter registration information into specific fields such as email, confirm email, password, confirm password, and others. Users can also review terms and conditions and select a corresponding button to confirm. Selection of a next button by a user can direct a lawyer user to a lawyer information page.

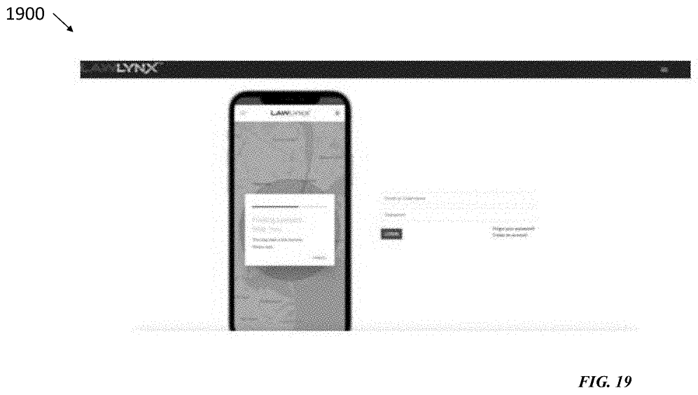

FIG. 19 illustrates a screenshot 1900 of a sign in page interface, according to some embodiments. As shown in the example embodiment, a lawyer user can sign into the platform by entering an email or username into an appropriate field and a password into a password field. Next the user can select a login button and the system can determine if the credentials match. Lawyer users can also select a forgot your password button and a create an account button.

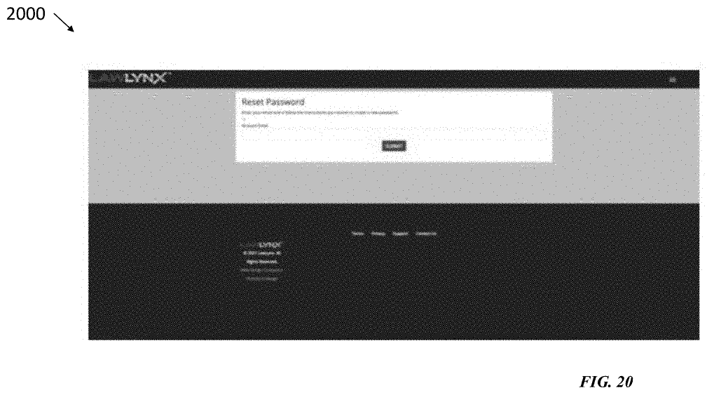

FIG. 20 illustrates a screenshot 2000 of a password reset page interface, according to some embodiments. As shown, users can reset their password by entering a recovery email or phone number.

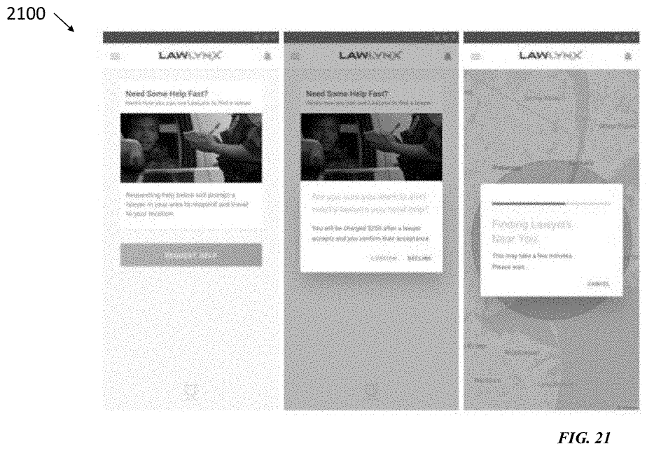

FIG. 21 illustrates screenshots 2100 of a home screens interface, according to some embodiments. As shown in the example embodiment, after a successful login, a user is presented with a home screen that includes a request help button. If selected, the user can find nearby lawyers.

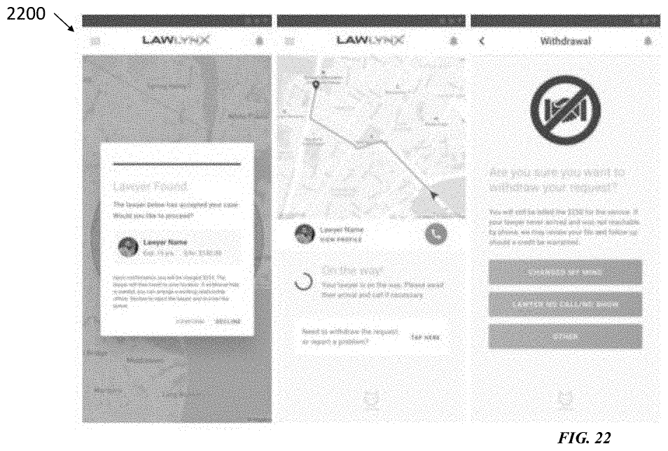

FIG. 22 illustrates a screenshot 2200 of a home screens interface, according to some embodiments. As shown in the example embodiment, nearby lawyers who are found can have their information presented to the user. If the user elects to confirm that lawyer, the lawyer may then be able to travel to the location of the user. Users can withdraw requests and/or report problems by selecting an appropriate button, and a call button is presented for a user to call the lawyer as well. If a user elects to withdraw a request, they may select a reason why. Users may be charged once they select the request lawyer button.

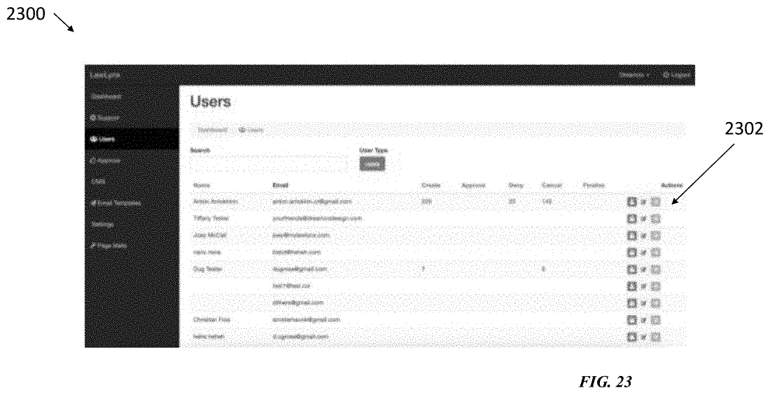

FIG. 23 illustrates a screenshot 2300 of a users page interface, according to some embodiments. As shown in the example embodiment, administrator users can search for users by name or email. They can also perform actions by interacting with buttons 2302.

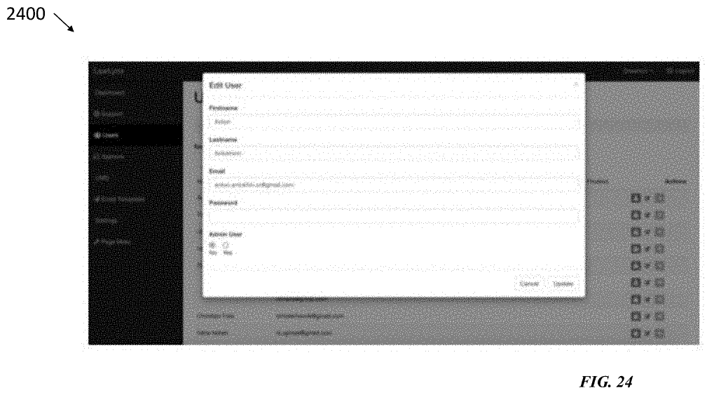

FIG. 24 illustrates a screenshot 2400 of a user edit page interface, according to some embodiments. As shown in the example embodiment, administrator users can edit user information by modifying fields.

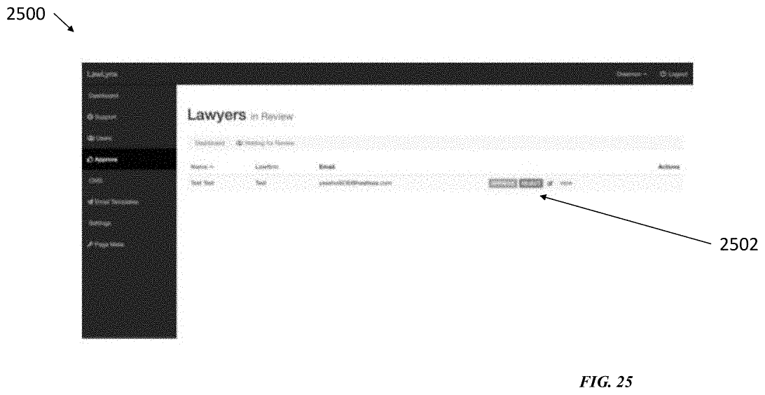

FIG. 25 illustrates a screenshot 2500 of an approve page interface, according to some embodiments. As shown in the example embodiment, administrator users can view a list of lawyers who are in review an approve or deny them by selecting an appropriate button 2502. Administrator users can also view lawyers' personal details and add any review notes.

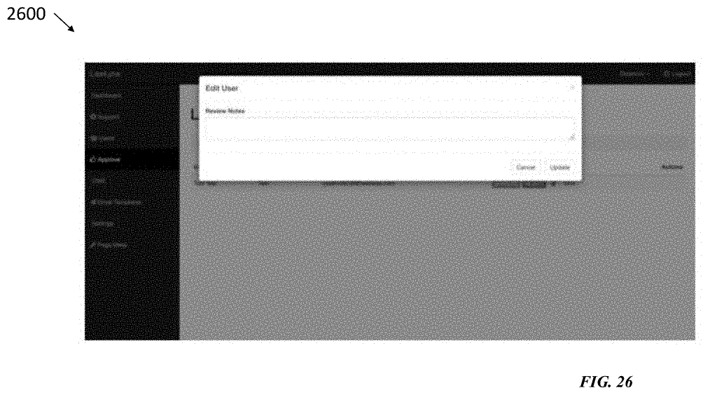

FIG. 26 illustrates a screenshot 2600 of a notes review approve page interface, according to some embodiments. As shown in the example embodiment, administrator users can enter review notes in an appropriate field.

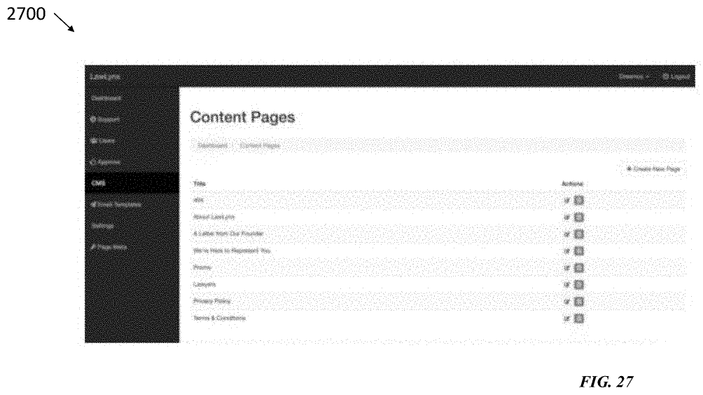

FIG. 27 illustrates a screenshot 2700 of a CMS page interface, according to some embodiments. As shown in the example embodiment, administrator users are able to create new pages and/or perform functions such as delete and edit on existing pages.

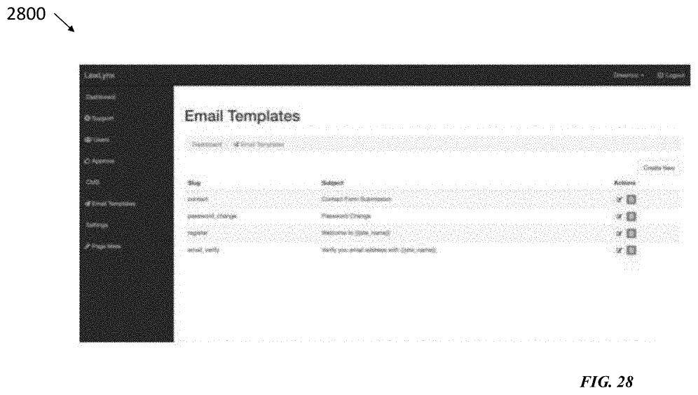

FIG. 28 illustrates a screenshot 2800 of an email template page interface, according to some embodiments. As shown in the example embodiment, administrator users can view a list of system email templates. Users can edit, add, and delete templates accordingly.

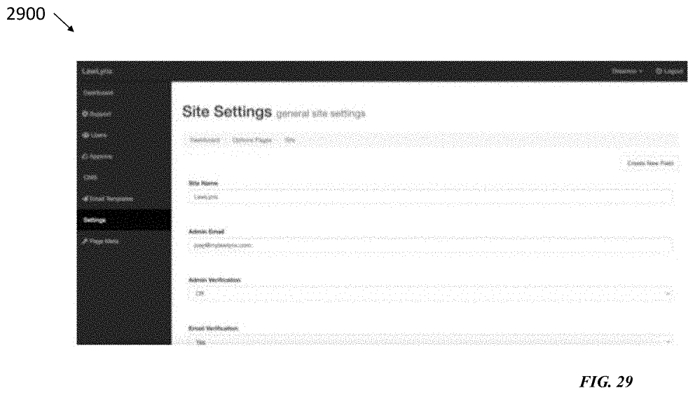

FIG. 29 illustrates a screenshot 2900 of a settings page interface, according to some embodiments. As shown in the example embodiment, administrator users can view and modify settings such as names, emails, verifications, authentications, and others. Users can also create new fields as desired.

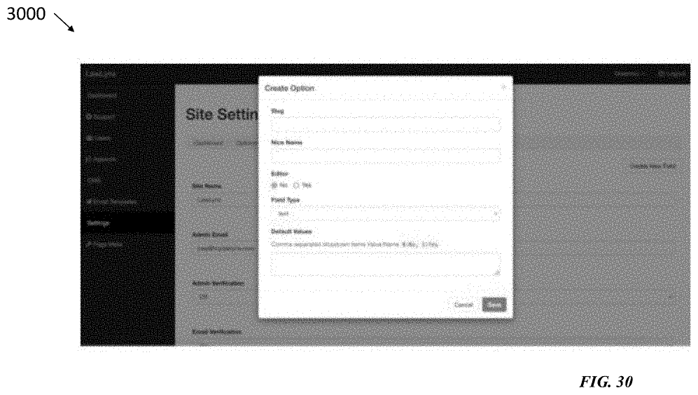

FIG. 30 illustrates a screenshot 3000 of a settings page create new field interface, according to some embodiments. As shown in the example embodiment, administrator users can create new fields by entering information and selecting appropriate buttons.

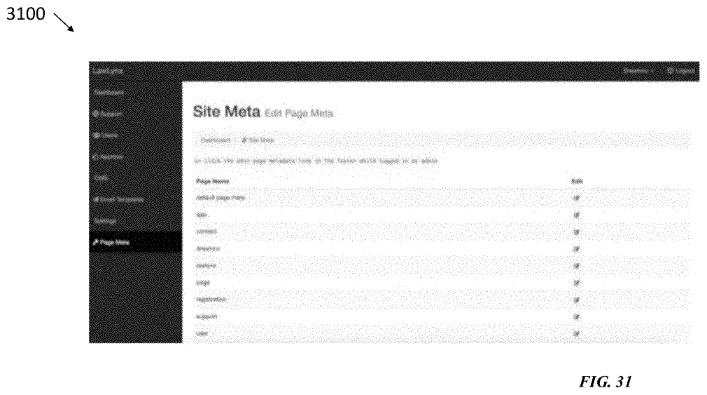

FIG. 31 illustrates a screenshot 3100 of a meta page interface, according to some embodiments. As shown in the example embodiment, administrator users can update meta records such as default page meta, ajax, contact, dreamco, lawlynx, page, registration, support, user, welcome, and others.

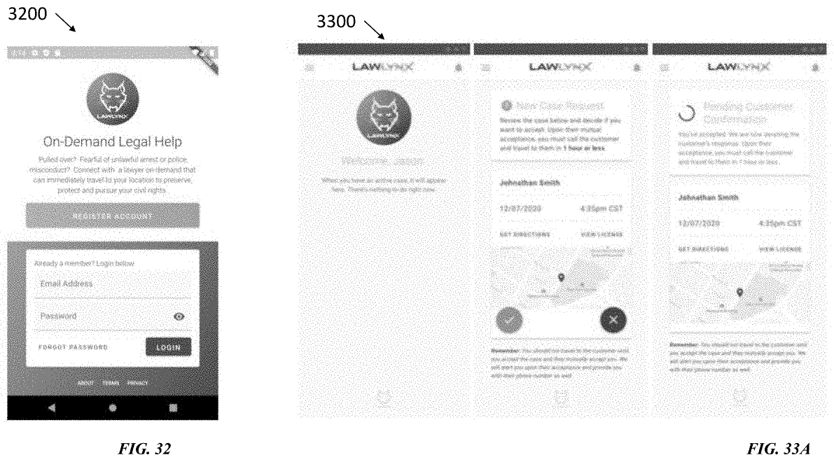

FIG. 32 illustrates a screenshot 3200 of a login screen interface, according to some embodiments. As shown in the example embodiment a lawyer mobile application can include a login screen with fields to enter contact information such as email and a password.

FIGS. 33A-33B illustrate screenshots 3300, 3350 of a home page interface, according to some embodiments. As shown in the example embodiments, a lawyer home screen can include a welcome screen if no cases are active. Otherwise, with active cases, a lawyer can view details, notifications, and accept or decline the case. They can also get directions to the client and view the client's license and call the client. Once a lawyer has helped a client they can finalize the case by selecting an end reason such as help provided, unable to call or locate, or other. If a client declines a lawyer, the lawyer may receive a popup notification with or without an explanation. Thereafter, the case will be removed from the lawyer's home screen.

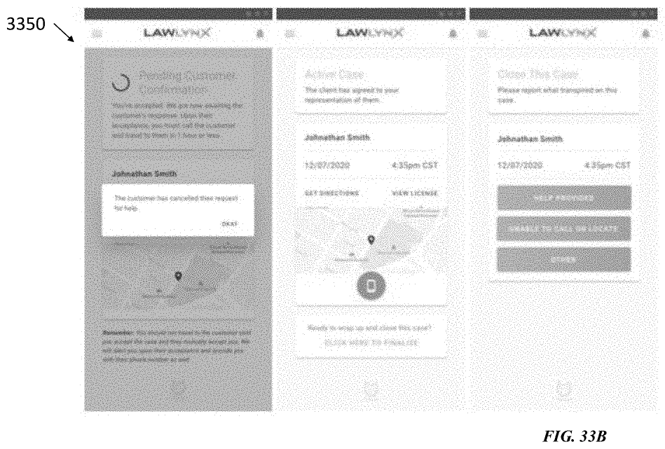

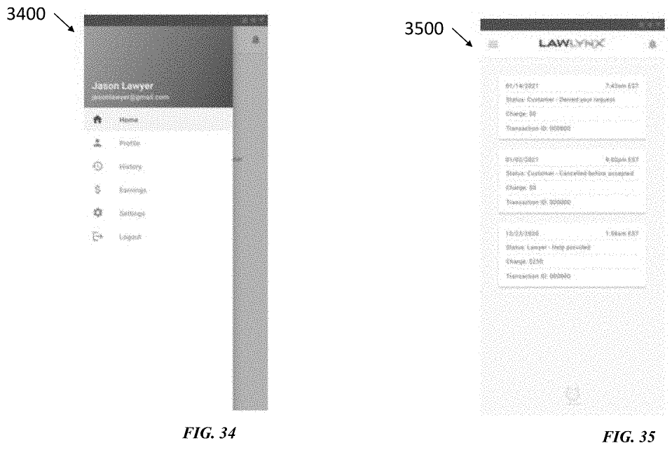

FIG. 34 illustrates a screenshot 3400 of a navigation menu interface, according to some embodiments. As shown in the example embodiment, the system can display to a lawyer user a number of buttons to navigate the system can include a home button, profile button, history button, earnings button, settings button, logout button, or others. The navigation menu can also include the lawyer name and contact information.

FIG. 35 illustrates a screenshot 3500 of a history screen interface, according to some embodiments. As shown in the example embodiment, date and time, case status, charge amount, transaction identification, and other information can be included on an earnings history screen for all cases connected with the lawyer.

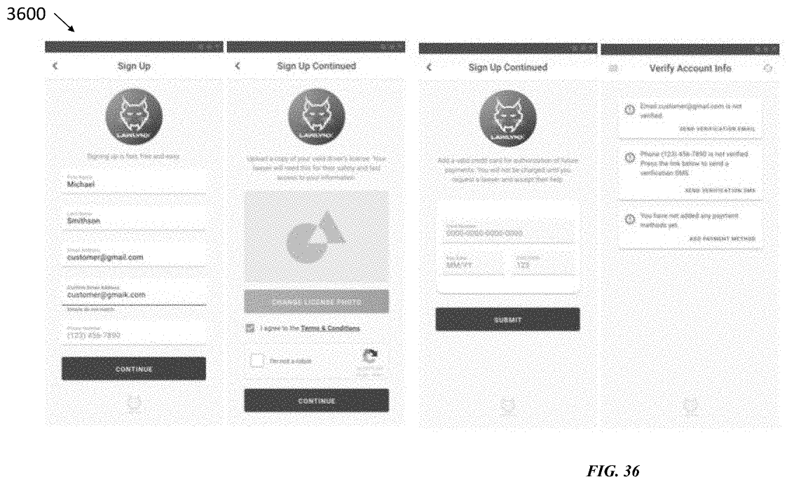

FIG. 36 illustrates screenshots 3600 of a sign up interface, according to some embodiments. As shown in the example embodiment, users can enter personal information, upload or take photographs of legal documents such as licenses, enter payment information such as bank or cryptocurrency information, verify account information such as by email or phone, or others.

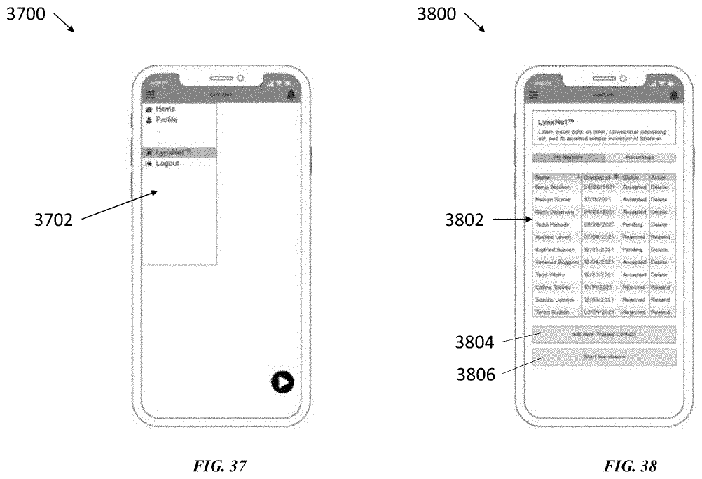

FIG. 37 illustrates a trusted network user interface initiation screen 3700, according to some embodiments. As shown in the example embodiment, a user can initialize a session with the system by selecting the system name in a menu 3702.

FIG. 38 illustrates a trusted network user interface screen 3800 with contacts, according to some embodiments. As shown in the example embodiment when a user has previously added one or more contacts to their trusted network, they can view a list of contacts 3802 by selecting a my network button. The user can also add net trusted contacts by selecting a button 3804. If the user wishes to begin a livestream, they can select an appropriate button 3806.

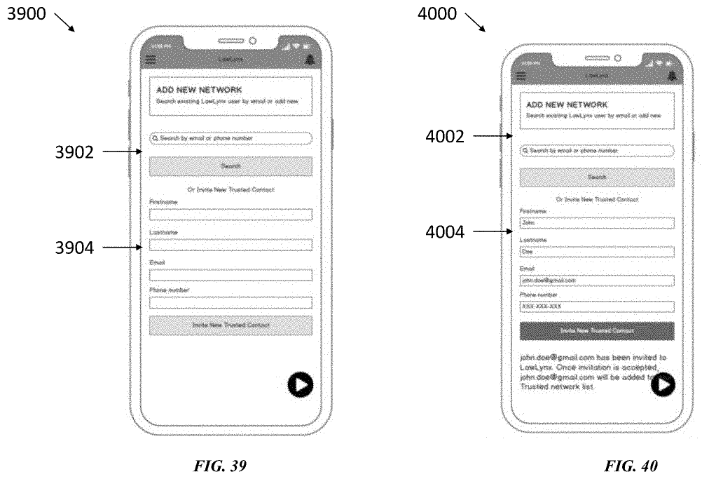

FIG. 39 illustrates a trusted network user interface network search screen 3900, according to some embodiments. As shown in the example embodiment, when a user wishes to add a new contact to their trusted network they can search by entering contact information such as an email, phone number, handle, or other information and selecting a search button in search section 3902. The user can also invite a new trusted contact to join the system by entering contact information in section 3904.

FIG. 40 illustrates a trusted network user interface network search screen 4000 with information included, according to some embodiments. As shown, the user has entered information into section 4004, which corresponds to section 3904 of FIG. 39.

FIG. 41 illustrates a trusted network user interface addition confirmation screen 4100, according to some embodiments. As shown in the example embodiment, when a user enters contact information for a trusted network contact, the system can display a confirmation 4102 that allows the user to confirm or deny by selecting a corresponding button in display section 4102.

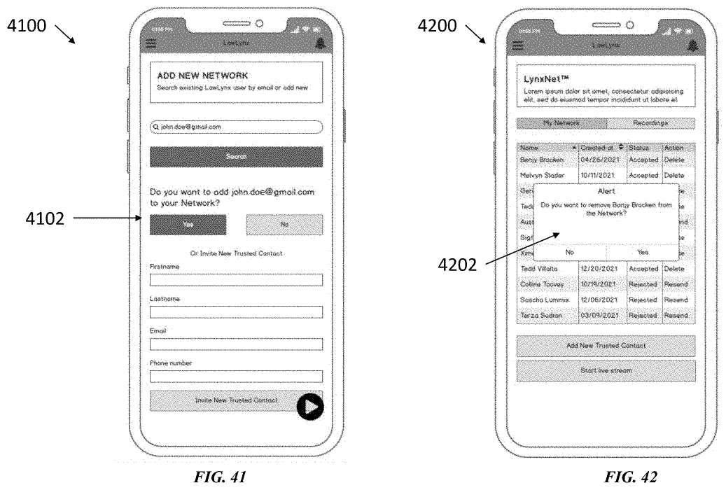

FIG. 42 illustrates a trusted network user interface removal confirmation screen 4200, according to some embodiments. As shown in the example embodiment, when a user wants to remove a contact from their trusted network, the system can display a confirmation window 4202 that allows the user to confirm or deny by selecting a corresponding button.

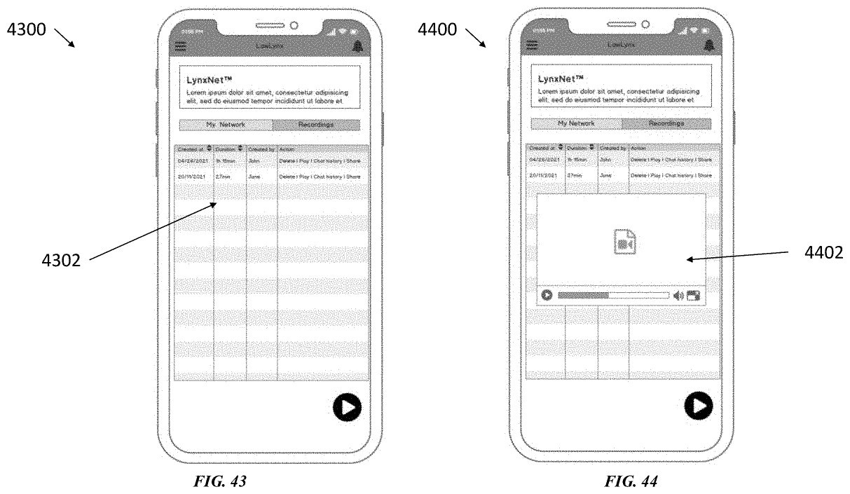

FIG. 43 illustrates a trusted network user interface recordings list screen 4300, according to some embodiments. As shown in the example embodiment, a list of recordings 4302 can include previously recorded sessions that may be used as evidence in cases at a later time or reviewed by trusted network contacts at their convenience.

FIG. 44 illustrates a trusted network user interface recording play screen 4400, according to some embodiments. As shown in the example embodiment, users can review a recording in a window 4402.

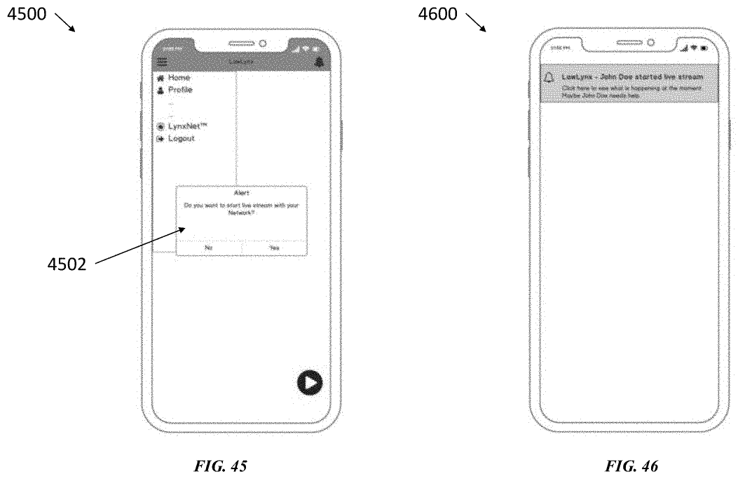

FIG. 45 illustrates a trusted network user interface stream start confirmation screen 4500, according to some embodiments. As shown in the example embodiment, the system can display a confirmation window 4502 that requires the user to confirm they wish to begin livestreaming an incident.

FIG. 46 illustrates a trusted network user interface alert screen 4600, according to some embodiments. As shown in the example embodiment, a notification can appear on trusted network contacts of a user when the user begins a livestream.

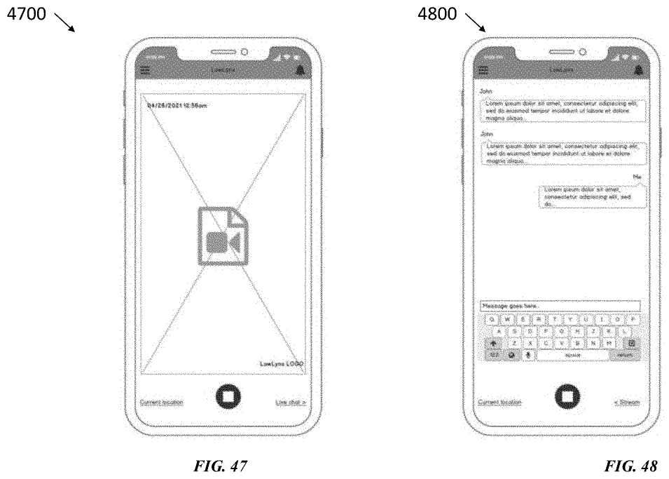

FIG. 47 illustrates a trusted network user interface livestream viewing screen 4700, according to some embodiments. As shown in the example embodiment, a livestream video can be displayed via a user interface display.

FIG. 48 illustrates a trusted network user interface comment screen 4800, according to some embodiments. As shown in the example embodiment, a user can chat via the system with trusted network contacts.

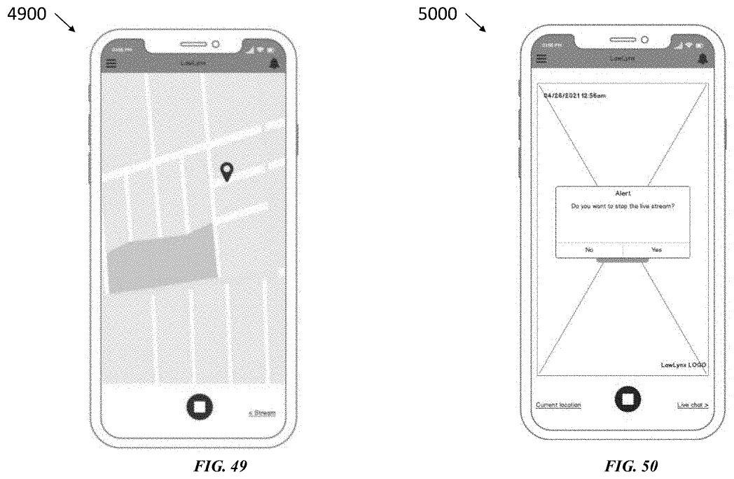

FIG. 49 illustrates a trusted network user interface location display screen 4900, according to some embodiments. As shown in the example embodiment, a user's location can be displayed on a map via the graphical user interface.

FIG. 50 illustrates a trusted network user interface livestream termination screen 5000, according to some embodiments. As shown in the example embodiment, the system can display an alert if the user selects a button to stop livestreaming.

In some embodiments, a pull-down list that users can change in their settings can be included. This can allow users to change the default area of law that the app will search for when they request on-demand, in person representation. For a streaming live video function, the user will be able to select from the pull-down menu in the video area.

In some embodiments, the time and date stamped invocation of a user's rights (the “Record”), will be tracked on a distributed ledger using blockchain technology. A process can include: 1. The User utilizes the app to invoke their civil rights (essentially reverse Miranda). 2. A time and date stamped digital notice (a “Themus Notice”) is generated that invokes their civil rights. 3. The Themus Notice is then sent electronically to the law enforcement jurisdiction that has been identified based on the user's geolocation. 4. The transmission of the Themus notice is added to the distributed ledger to create a permanent record that can be used in subsequent legal proceedings to prevent coerced false confessions and wrongful convictions.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A system for providing on-demand legal counsel, the system comprising:
a database in operable communication with a computing device, the computing device in communication with a user interface module to display information on a display of the computing device;
a user profile interface to permit the input of a plurality of profile information and a plurality of preferences, wherein a matching engine uses the plurality of profile information and the plurality of preferences to match a lawyer with a user.

2. The system of claim 1, further comprising a GPS module to indicate a location of the user and the lawyer.

3. The system of claim 2, wherein the matching engine is in operable communication with the GPS module to permit the matching engine to match the user to the lawyer by location.

4. The system of claim 1, wherein the GPS module determines a juristic entity.

5. The system of claim 4, wherein the system transmit a letter of representation to the juristic entity.

6. The system of claim 4, wherein the system provides a civil rights invocation to the computing device for display on a user interface to a law enforcement officer.

7. The system of claim 1, wherein the user profile includes at least one trusted contact designated by the user.

8. The system of claim 7, wherein the trusted contact is a friend or family member.

9. The system of claim 7, wherein the trusted contact is a lawyer who represents the user.

10. The system of claim 7, wherein the computing device streams video for viewing by the trusted contact based on a user interaction with a stream video button of the computing device.

11. A method for providing on-demand legal counsel via a data network, comprising instructions stored in non-transitory computer readable memory that, when executed by a processor, cause the processor to perform the steps of:
displaying, via a user interface of a computing device an application that allows a user to connect with a lawyer whose information is stored in a database of lawyers and is in operable communication with a computing device; and
receives and stores a plurality of profile information and a plurality of preferences from a user,
wherein a matching engine uses the plurality of profile information and the plurality of preferences to match the lawyer with the user.

12. The method of claim 10, wherein a GPS module is used to match a location of the user and the lawyer.

13. The method of claim 11, wherein the matching engine is in operable communication with the GPS module to permit the matching engine to match the user to the lawyer by location.

14. The method of claim 10, wherein the GPS module determines a juristic entity.

15. The method of claim 13, wherein the a letter of representation is transmitted to the juristic entity.

16. The method of claim 13, wherein a civil rights invocation is provided to the computing device for display on a user interface to a law enforcement officer.

17. The method of claim 1, wherein the user profile includes at least one trusted contact designated by the user.

18. The system of claim 16, wherein the trusted contact is a friend or family member.

19. The system of claim 16, wherein the trusted contact is a lawyer who represents the user.

20. The method of claim 16, wherein the computing device streams video for viewing by the trusted contact based on a user interaction with a stream video button of the computing device.
